(19) United States
(12) Patent Application Publication
(10) Pub. No.: US 2019/0186504 A1
(43) Pub. Date: Jun. 20, 2019

(54) ASPIRATOR SYSTEM

(71) Applicant: Goodrich Corporation, Charlotte, NC (US)

(72) Inventors: Jeff M. Werbelow, Phoenix, AZ (US); Jagadish Thammanna, Bangalore (IN); Krishna Preetham Somasundaram, Bangalore (IN); Shyamkumar Dattatri, Bangalore (IN)

(21) Appl. No.: 16/223,152

(22) Filed: Dec. 18, 2018

(30) Foreign Application Priority Data
Dec. 19, 2017 (IN) 201711045610

(51) Int. Cl. F04F 5/46; B60C 29/00; B64D 25/14; F04F 5/16

(52) U.S. Cl. CPC F04F 5/467; B63C 9/24; B63C 2009/0023; F04F 5/16; F04F 5/461; B64D 25/14

(57) ABSTRACT

An aspirator system for inflating an inflatable device includes an aspirator body and a plurality of nozzles. The aspirator body has an inner surface and an outer surface that each extend between a first end and a second end along a central longitudinal axis. The aspirator body defines a distribution channel that is disposed between the inner surface and the outer surface. The plurality of nozzles are fluidly connected to the distribution channel and extend inwardly from the inner surface towards but are spaced apart from the central longitudinal axis.

### CROSS-REFERENCE TO RELATED APPLICATIONS

This patent application claims priority to Indian Provisional Patent Application Serial No. 201711045610, filed Dec. 19, 2017, which is incorporated herein by reference in its entirety.

### BACKGROUND

Exemplary embodiments pertain to the art of aspirators.

Aspirators are used to entrain ambient air into an inflatable structure during inflation. A high velocity primary gas may be ejected through nozzles of the aspirator and the high velocity primary gas is directed into the inflatable structure leading to a pressure differential which entrains ambient air into the inflatable structure. Blockage within the flow path of the aspirator may reduce the efficiency of the aspirator. There is a need in the industry for a device that has a reduced blockage area that results in higher efficiency through a higher secondary flow.

### BRIEF DESCRIPTION

Disclosed is an aspirator system for inflating an inflatable device. The aspirator system includes an aspirator body and a plurality of nozzles. The aspirator body has an inner surface and an outer surface that each extend between a first end and a second end along a central longitudinal axis. The aspirator body defines a distribution channel that is disposed between the inner surface and the outer surface. The plurality of nozzles are fluidly connected to the distribution channel and extend inwardly from the inner surface towards the central longitudinal axis.

In addition to one or more of the features described herein, the plurality of nozzles are spaced apart from the central longitudinal axis such that a central flow path is disposed about the central longitudinal axis and is free of blockage from any portion of the plurality of nozzles.

Also disclosed is an aspirator system. The aspirator system includes an aspirator body and a plurality of nozzles. The aspirator body extends between a first end and a second end along a central longitudinal axis. The aspirator body defines a distribution channel. The plurality of nozzles are fluidly connected to the distribution channel. Each nozzle of the plurality of nozzles includes a first portion that extends inwardly towards the central longitudinal axis and a second portion that extends from the first portion.

### BRIEF DESCRIPTION OF THE DRAWINGS

The following descriptions should not be considered limiting in any way. With reference to the accompanying drawings, like elements are numbered alike:

FIG. 1 is a cross-sectional view of an aspirator system;

FIG. 2 is an end view of the aspirator system;

FIG. 3 is a partial perspective view of a portion of the aspirator system;

FIG. 4 is a cross-sectional view of a nozzle member disposed within a nozzle of the aspirator system; and

FIG. 5 is a simplified cross-sectional view of the aspirator system.

### DETAILED DESCRIPTION

A detailed description of one or more embodiments of the disclosed apparatus and method are presented herein by way of exemplification and not limitation with reference to the Figures.

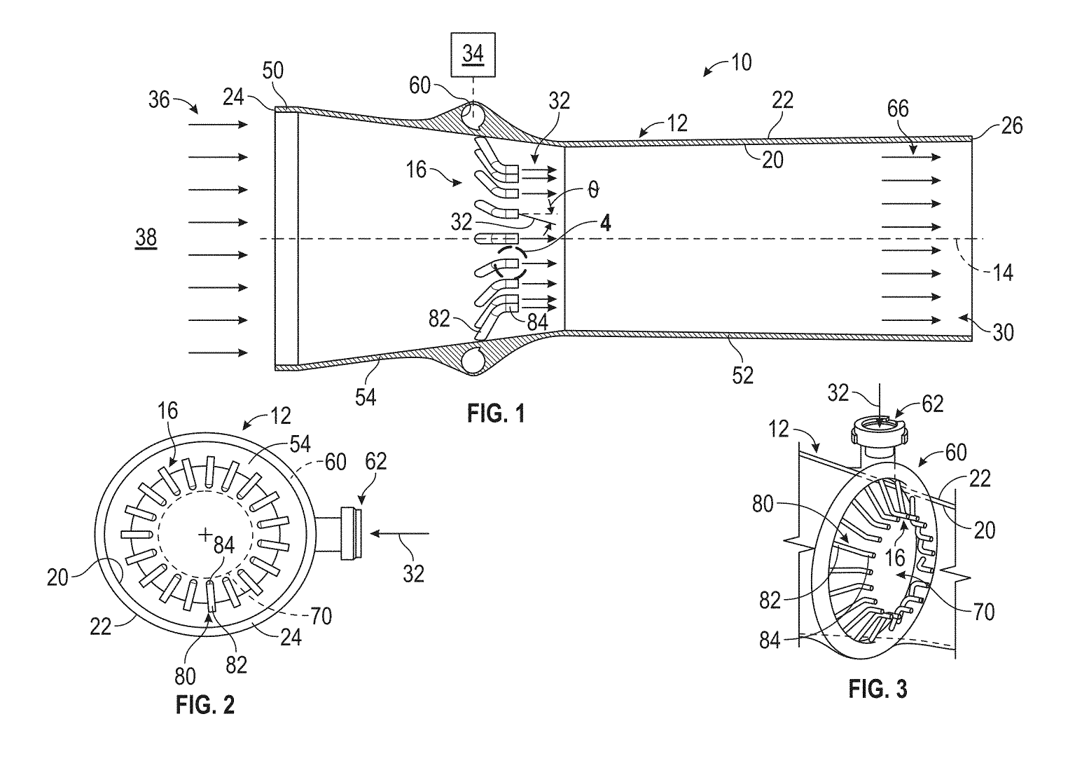

Referring to FIGS. 1 and 5, an aspirator system 10 is illustrated. The aspirator system 10 includes an aspirator body 12 that extends along a longitudinal axis 14 and a plurality of nozzles 16. The longitudinal axis 14 may be a central longitudinal axis about which the aspirator body 12 and the plurality of nozzles 16 are disposed.

The aspirator body 12 includes an inner surface 20 and an outer surface 22 that each extend between a first end 24 and a second end 26 along the longitudinal axis 14. The inner surface 20 of the aspirator body 12 defines a fluid channel 30 that receives a first fluid flow 32 from a first fluid source 34 and receives/entrains/induces a second fluid flow 36 from a second fluid source 38. The first fluid flow 32 and the second fluid flow 36 are mixed within the fluid channel 30 and are discharged into an inflatable structure or inflatable device that is disposed downstream of the second end 26. The inflatable structure or inflatable device may be an aircraft evacuation slide, an emergency life raft, or other devices that may be inflated.

The first fluid source 34 may be a pressurized gas source that is discharged into the fluid channel 30 at a high velocity through the plurality of nozzles 16. The second fluid source 38 may be ambient air or a lower pressure gas source as compared to the first fluid source 34.

The aspirator body 12 includes an inlet section 50, an outlet section 52, and a nozzle section 54 that is disposed between the inlet section 50 and the outlet section 52. The inlet section 50 extends from the first end 24 towards the second end 26. The inlet section 50 may have a substantially constant cross-sectional form or diameter. The outlet section 52 extends from the second end 26 towards the first end 24. The outlet section 52 may have a substantially constant cross-sectional form or diameter. The nozzle section 54 is disposed between the first end 24 and the second end 26 and extends between the inlet section 50 and the outlet section 52. The nozzle section 54 may have a cross-sectional form or diameter that decreases such that the inner surface 20 becomes progressively closer to the longitudinal axis 14 in a direction that extends from the inlet section 50 towards the outlet section 52.

Referring to FIGS. 1, 2, 3, and 5, the aspirator body 12 defines a distribution channel 60 that is defined between the inner surface 20 and the outer surface 22. The distribution channel 60 may be disposed within or defined within the nozzle section 54 and is disposed about the aspirator body 12. The distribution channel 60 is arranged to receive the first fluid flow 32 from the first fluid source 34 through a fluid inlet 62. The fluid inlet 62 is disposed generally perpendicular to the longitudinal axis 14 and the distribution channel 60.

The plurality of nozzles 16 are fluidly connected to the distribution channel 60 and extend from the inner surface 20 into the fluid channel 30 towards the longitudinal axis 14. The plurality of nozzles 16 are disposed about and spaced apart from the longitudinal axis 14. The first fluid flow 32 from the first fluid source 34 flows through the distribution channel 60 and exits or is ejected through the plurality of nozzles 16 into the fluid channel 30. The first fluid flow 32 exits the plurality of nozzles 16 at a high velocity causing a pressure differential or creates a low pressure region that is disposed downstream of the plurality of nozzles 16 to induce or entrain the second fluid flow 36 from the second fluid source 38 to enter into the fluid channel 30 through the inlet section 50. The first fluid flow 32 and the second fluid flow 36 are mixed downstream of the plurality of nozzles 16. As shown in FIG. 1, a combination 66 of the first fluid flow 32 and the second fluid flow 36 is directed towards and into the inflatable structure.

The plurality of nozzles 16 extend from the inner surface 20 of the nozzle section 54 of the aspirator body 12 towards the longitudinal axis 14. The plurality of nozzles 16 are positioned within the nozzle section 54. The plurality of nozzles 16 are spaced apart from the longitudinal axis 14 such that a central flow path 70, as shown in FIGS. 2 and 3, is disposed about the longitudinal axis 14 and is free of blockage from any portion of the plurality of nozzles 16, the aspirator body 12, or the distribution channel 60. At least a portion of the second fluid flow 36 is entrained through the central flow path 70.

Each nozzle 80 of the plurality of nozzles 16 is fluidly connected to the distribution channel 60 and includes a first portion 82 and a second portion 84. The first portion 82 is connected to the distribution channel 60 and extends inwardly from the inner surface 20 of the aspirator body 12 towards the longitudinal axis 14. The first portion 82 is disposed in a non-parallel and a non-perpendicular relationship with respect to the longitudinal axis 14. The second portion 84 extends from the first portion 82 and is spaced apart from the inner surface 20 and the longitudinal axis 14. The central flow path 70 may be circumscribed by or defined by an inner circumferential surface of the second portion 84 of the plurality of nozzles 16 that faces towards the longitudinal axis 14, as shown in FIGS. 2 and 3.

Referring to a portion of FIG. 1, the second portion 84 may be disposed generally parallel to the longitudinal axis 14. The first fluid flow 32 may exit the second portion 84 and may flow generally parallel to the longitudinal axis 14.

Referring to another portion of FIG. 1, the second portion 84 may be disposed in a non-parallel relationship with respect to the longitudinal axis 14. The second portion 84 may be disposed at an angle, θ, relative to the longitudinal axis 14, such that the first fluid flow 32 is directed towards the longitudinal axis 14.

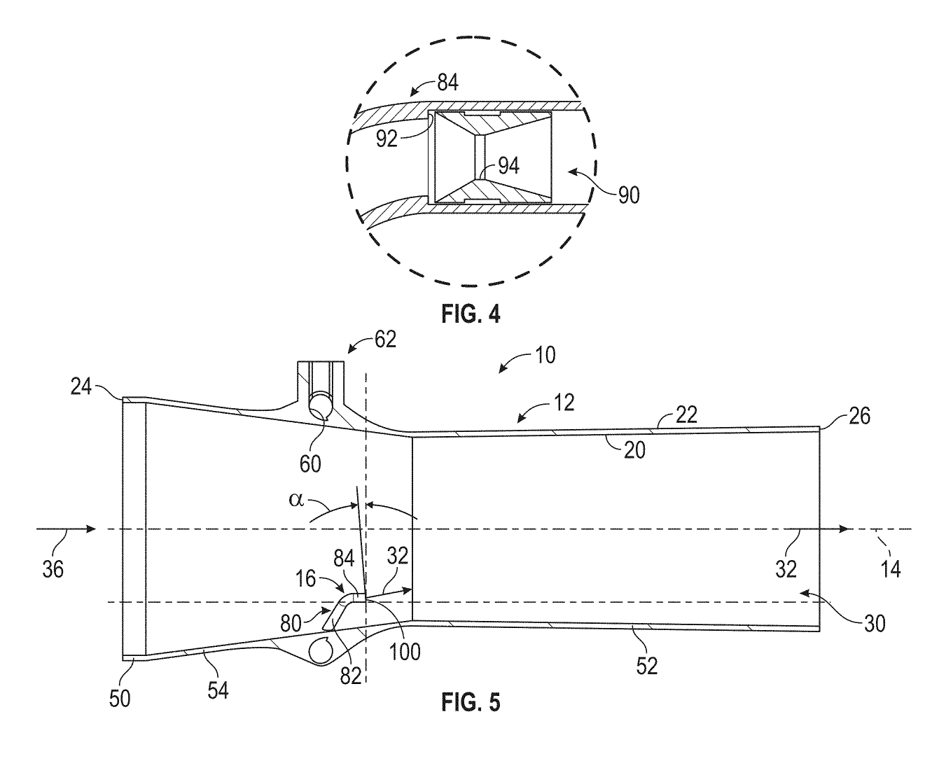

Referring to FIG. 4, the second portion 84 of each nozzle 80 is arranged to receive a nozzle member 90. The nozzle member 90 is disposed within the second portion 84 and is disposed adjacent to or abuts a stop surface 92 that is defined by the second portion 84. The nozzle member 90 may be configured as a converging-diverging nozzle having an orifice 94.

Referring to FIG. 5, the second portion 84 may be disposed generally parallel to the longitudinal axis 14. The second portion 84 defines an exit face 100 through which the first fluid flow 32 may exit. The exit face 100 may be disposed at an angle, a, relative to the longitudinal axis 14, such that the first fluid flow 32 is directed towards the longitudinal axis 14.

The plurality of nozzles 16 of the aspirator system 10 supply the first fluid flow 32 from an inner periphery of the aspirator body 12, reducing a blockage area and encouraging the entrainment or inducement of flow through the central flow path 70. This arrangement improves aspirator efficiency and reduces the overall volume of the aspirator body 12, leading to reduced weight and packaging area. Aspirator efficiency is a measurement that relates an amount of the second fluid flow 36 that flows through the fluid channel 30 to an amount of the first fluid flow 32 through the plurality of nozzles 16. The aspirator efficiency is increased due to the higher flow entrainment of the second fluid flow 36 into the fluid channel 30 through the central flow path 70.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An aspirator system, comprising:
an aspirator body having an inner surface and an outer surface that each extend between a first end and a second end along a central longitudinal axis, the aspirator body defining a distribution channel that is disposed between the inner surface and the outer surface; and
a plurality of nozzles that are fluidly connected to the distribution channel and extends inwardly from the inner surface towards the central longitudinal axis.

2. The aspirator system of claim 1, wherein each orifice of the plurality of nozzles includes a first portion and a second portion that extends from the first portion.

3. The aspirator system of claim 2, wherein the first portion extends towards and is disposed in a non-parallel and a non-perpendicular relationship with respect to the central longitudinal axis.

4. The aspirator system of claim 2, wherein the aspirator body includes:
a nozzle section that is disposed between the first end and the second end.

5. The aspirator system of claim 4, wherein the distribution channel is disposed within the nozzle section.

6. The aspirator system of claim 2, wherein the distribution channel is arranged to receive a first fluid flow from a first fluid source.

7. The aspirator system of claim 6, wherein the second portion is disposed parallel to the central longitudinal axis.

8. The aspirator system of claim 7, wherein the second portion defines an exit face.

9. The aspirator system of claim 8, wherein the exit face is angled relative to the central longitudinal axis such that the first fluid flow is directed towards the central longitudinal axis.

10. An aspirator system, comprising:
an aspirator body extending between a first end and a second end along a central longitudinal axis, the aspirator body defining a distribution channel; and
a plurality of nozzles that are fluidly connected to the distribution channel, each nozzle of the plurality of nozzles includes a first portion that extends inwardly towards the central longitudinal axis and a second portion that extends from the first portion.

11. The aspirator system of claim 10, wherein the aspirator body includes:
an inlet section that extends from the first end towards the second end;
an outlet section that extends from the second end towards the first end; and
a nozzle section that extends between the inlet section and the outlet section.

12. The aspirator system of claim 11, wherein the distribution channel is defined within the nozzle section.

13. The aspirator system of claim 11, wherein the distribution channel is arranged to receive a first fluid flow from a first fluid source.

14. The aspirator system of claim 13, wherein the inlet section is arranged to receive a second fluid flow from a second fluid source.

15. The aspirator system of claim 14, wherein the second portion is disposed parallel to the central longitudinal axis.

16. The aspirator system of claim 14, wherein a nozzle member is disposed within the second portion.

17. The aspirator system of claim 14, wherein the second portion is disposed in a non-parallel relationship with respect to the central longitudinal axis.

18. The aspirator system of claim 17, wherein the second portion is angled relative to the central longitudinal axis such that the first fluid flow is directed towards the central longitudinal axis.
